(19) United States
(12) Patent Application Publication
(10) Pub. No.: US 2021/0183388 A1
(43) Pub. Date: Jun. 17, 2021

(54) VOICE RECOGNITION METHOD AND DEVICE, PHOTOGRAPHING SYSTEM, AND COMPUTER-READABLE STORAGE MEDIUM

(71) Applicant: SZ DJI TECHNOLOGY CO., LTD., Shenzhen (CN)

(72) Inventor: Wenquan ZHAO, Shenzhen (CN)

(21) Appl. No.: 17/187,156

(22) Filed: Feb. 26, 2021

Related U.S. Application Data
(63) Continuation of application No. PCT/CN2018/103219, filed on Aug. 30, 2018.

(51) Int. Cl. G10L 15/22; G10L 15/02; G10L 15/18; G10L 15/14

(52) U.S. Cl. CPC G10L 15/22; G10L 15/14; G10L 15/18; G10L 15/02

(57) ABSTRACT

A voice recognition method includes obtaining a voice command inputted by a user for performing a voice control of a terminal device; determining an operation state of the terminal device; determining a target voice recognition model corresponding to the operation state; and recognizing the voice command using the target voice recognition model.

### CROSS-REFERENCE TO RELATED APPLICATION

This application is a continuation of International Application No. PCT/CN2018/103219, filed on Aug. 30, 2018, the entire content of which is incorporated herein by reference.

### TECHNICAL FIELD

The present disclosure relates to the technical field of speech processing and, more particularly, to a voice recognition method and device, a photographing system, and a computer-readable storage medium.

### BACKGROUND

As the most natural way of human interaction, voice is also suitable for human-machine interaction. Currently, most terminal devices on the market for the human-machine interaction have a graphic interaction interface, which requires a user to keep an eye on the interface and is operated by hand. This increases complexity of user's operation. Therefore, to make the user's operation convenient, terminal devices capable of voice recognition emerged. Such terminal devices can recognize a voice command spoken by the user, and perform a corresponding action based on the recognized voice command.

In the existing technology, most terminal devices adopt a single voice recognition model globally, which not only increases the complexity of voice recognition model training, but also reduces voice recognition efficiency of the terminal device, thereby not favoring the advancement of smart terminal devices.

### SUMMARY

In accordance with the disclosure, there is provided a voice recognition method. The method obtaining a voice command inputted by a user for performing a voice control of a terminal device; determining an operation state of the terminal device; determining a target voice recognition model corresponding to the operation state; and recognizing the voice command using the target voice recognition model.

In accordance with the disclosure, there is provided a photographing system. The photographing system includes a photographing device and a voice recognition device communicatively connected to the photographing device. The voice recognition device includes a memory storing a computer program and a processor configured to execute the computer program to: obtain a voice command inputted by a user for performing a voice control of a terminal device; determine an operation state of the terminal device; determine a target voice recognition model corresponding to the operation state; and recognize the voice command using the target voice recognition model.

### BRIEF DESCRIPTION OF THE DRAWINGS

FIG. 1 is a flowchart of a voice recognition method according to an example embodiment of the present disclosure.

FIG. 2 is a flowchart of recognizing a voice command using a target voice recognition model according to an example embodiment of the present disclosure.

FIG. 3 is a flowchart of recognizing a keyword using the target voice recognition model according to an example embodiment of the present disclosure.

FIG. 4 is a flowchart of recognizing a keyword using probability information of each standard keyword relative to the extracted keyword according to an example embodiment of the present disclosure.

FIG. 5 is a flowchart of determining a target keyword corresponding to the extracted keyword among multiple standard keywords based on the probability information and relative probability information according to an example embodiment of the present disclosure.

FIG. 6 is a flowchart of determining an operation state of a terminal device according to an example embodiment of the present disclosure.

FIG. 7 is a flowchart of a voice recognition method according to another example embodiment of the present disclosure.

FIG. 8 is a schematic structural diagram of a voice recognition device according to an example embodiment of the present disclosure.

FIG. 9 is a schematic structural diagram of a voice recognition device according to another example embodiment of the present disclosure.

### DETAILED DESCRIPTION OF THE EMBODIMENTS

To make objectives, technical solutions, and advantages of the embodiments of the present disclosure clearer, the technical solutions in the embodiments of the present disclosure are described in detail below with reference to the accompanying drawings. It will be appreciated that the described embodiments are some rather than all of the embodiments of the present disclosure. Other embodiments obtained by those having ordinary skills in the art on the basis of the described embodiments without inventive efforts should fall within the scope of the present disclosure.

Unless otherwise defined, all technical and scientific terms used in this disclosure have the same meaning as commonly understood by those of ordinary skill in the art. The terms used in the present disclosure are only for descriptive purposes, and are not intended to limit the present disclosure.

Hereinafter, some embodiments of the present disclosure will be further described in detail with reference to the accompanying drawings in the specification. In case of no conflict, the embodiments and features described in the embodiments can be combined with each other.

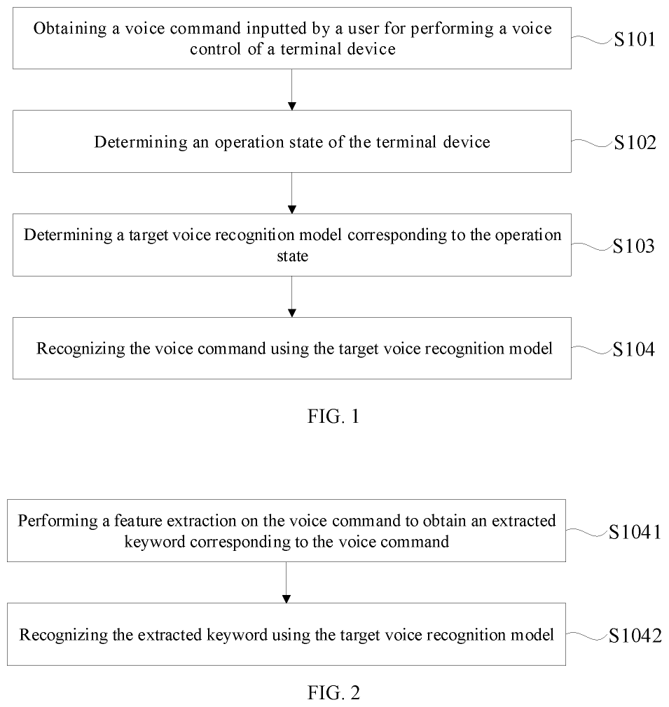

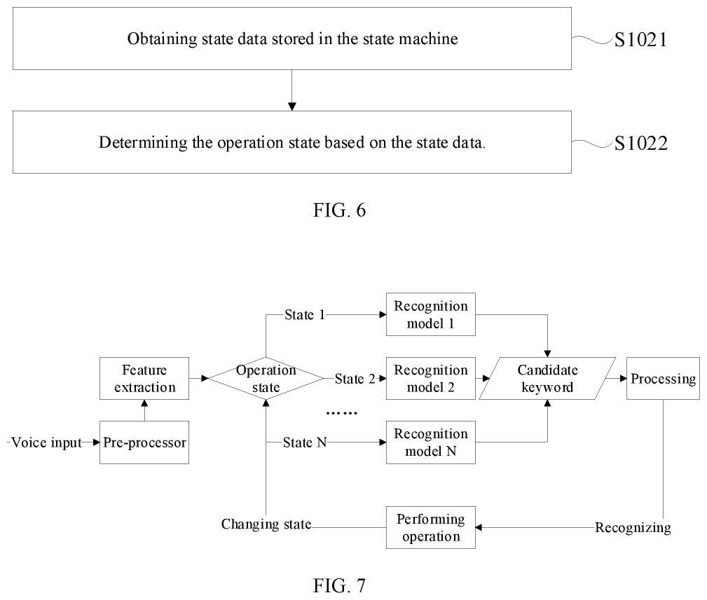

FIG. 1 is a flowchart of a voice recognition method according to an example embodiment of the present disclosure. FIG. 6 is a flowchart of determining an operation state of a terminal device according to an example embodiment of the present disclosure. Referring to FIG. 1 and FIG. 6, the embodiments of the present disclosure provide a voice recognition method for quick and accurate voice recognition. Specifically, the method includes the following processes.

At S101: a voice command inputted by a user for performing a voice control of a terminal device is obtained. The terminal device may be one or more of a smart phone, a vehicle-mounted terminal, a photographing device, and a wearable device (a watch or a wrist band). The obtained voice command is used to perform the voice control of the terminal device.

At S102, an operation state of the terminal device is determined. Different terminal devices may have different operation states. For example, if the terminal device is the smart phone, the operation state of the smart phone includes at least one of a standby state or a call state. If the terminal device is the vehicle-mounted terminal, the operation state of the vehicle-mounted terminal includes at least one of a music playing state, a navigation state, or an image displaying state. If the terminal device is the photographing device, the operation state of the photographing device includes at least one of a standby state, a camera operating state, or a photographing state.

Further, the terminal device in different operation states provides different application modes. For example, if the terminal device is the smart phone, when the smart phone is in the standby state, the application mode of the smart phone includes a Bluetooth connection mode, a Wi-Fi connection mode, and/or a flight mode. If the terminal device is the photographing device, when the photographing device is in the photographing state, the application mode of the photographing device includes a delayed photographing mode, a slow-motion photographing mode, and/or a normal photographing mode.

Therefore, to improve the control accuracy and recognition efficiency of the terminal device, the operation state of the terminal device is determined. In the embodiments of the present disclosure, a specific method of determining the operation state is not provided. For example, different operation states of a terminal device may correspond to different ranges of voltage information and/or current information. The voltage information and/or the current information of the terminal device may be obtained. The operation state of the terminal device may be determined according to the obtained voltage information and/or the current information. In some embodiments, another method can be used to determine the operation state of the terminal device, as long as the accuracy of the determined operation state is ensured. Further description is omitted.

In some embodiments, to improve the efficiency and accuracy of determining the operation state, the terminal device includes a state machine. The state machine stores state data corresponding to the operation state of the terminal device. In this case, determining the operation state of the terminal device includes the following processes, as shown in FIG. 6.

At S1021, the state data stored in the state machine is obtained.

Specifically, a query command is sent to the state machine. In response to the query command, the state machine determines the state data corresponding to the current operation state to obtain the state data.

At S1022, the operation state is determined based on the state data.

The state data stored in the state machine corresponds to the current operation state of the terminal device, and different state data correspond to different operation states. Thus, after the state data is obtained, the operation state of the terminal device can be determined based on the state data. For example, the terminal device is the photographing device. When the obtained state data is 01, the operation state of the photographing device can be determined to be the standby state based on the state data 01. When the obtained state data is 02, the operation state of the photographing device can be determined to be the camera operating state based on the state data 02.

Referring again to FIG. 1, at S103, a target voice recognition model corresponding to the operation state is determined based on the operation state.

Each operation state of the terminal device may correspond to one voice recognition model, and each voice recognition model has different recognition database. In one example, the terminal device is the smart phone. When the operation state of the smart phone is the call state, the recognition database of the target voice recognition model corresponding to the operation state may include recognition keywords such as keep the call, hang up the call, mute, and hands-free, etc. When the operation state of the smart phone is the standby state, the recognition database of the target voice recognition model corresponding to the operation state may include the recognition keywords such as make phone call, play music, look up, and search, etc. In another example, the terminal device is the photographing device. When the operation state of the photographing device is the photographing state, the recognition database of the target voice recognition model corresponding to the operation state may include recognition keywords such as stop photographing, and highlight, etc. When the operation state of the photographing device is the camera operating state, the recognition database of the target voice recognition model corresponding to the operation state may include recognition keywords such as start photographing, shut down, and take photo, etc.

Therefore, after the operation state is determined, the target voice recognition model is determined based on the operation state. The voice recognition model is used to perform a voice recognition processing on the terminal device in the corresponding operation state.

At S104, the target voice recognition model is used to recognize the voice command.

After the voice recognition model is determined, the target voice recognition model is used to recognize the voice command inputted by the user, thereby improving the accuracy and efficiency of the voice recognition.

In the voice recognition method provided by the embodiments of the present disclosure, after the operation state of the terminal device is determined, the target voice recognition model corresponding to the operation state is determined. The target voice recognition model is used to recognize the voice command, such that different voice recognition model is used for different operation state of the terminal device. Thus, it not only reduces complexity of voice recognition model training, but also improves the efficiency and accuracy of voice recognition of the terminal device, which helps advancement of smart terminal devices and improves adoption of the disclosed method.

FIG. 2 is a flowchart of recognizing a voice command using a target voice recognition model according to an example embodiment of the present disclosure. The present disclosure does not limit how to recognize the voice command using the target voice recognition model. As shown in FIG. 2, recognizing the voice command using the target voice recognition model includes the following processes.

At S1041, a feature extraction is performed on the voice command to obtain an extracted keyword corresponding to the voice command.

For example, the voice command inputted by the user is “please play a song for me.” The feature extraction is performed on the voice command to obtain extracted keywords such as “play, song” corresponding to the voice command. In another example, the voice command inputted by the user is “please help me turn on the hands-free.” The feature extraction is performed on the voice command to obtain the extracted keywords such as “turn on, hands-free” corresponding to the voice command.

At S1042, the target voice recognition model is used to recognize the extracted keyword.

Because the keyword extracted from the voice command comprehensively indicates the meaning and intention of the voice command, after the keyword extracted from the voice command is obtained, the target voice recognition model is used to recognize the extracted keyword, thereby improving the efficiency and accuracy of recognizing the voice command.

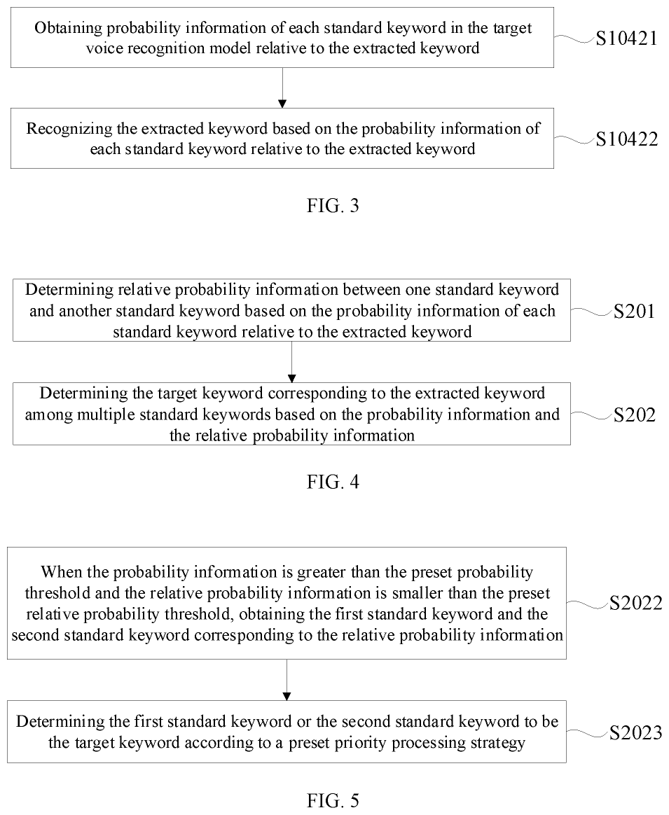

FIG. 3 is a flowchart of recognizing a keyword using the target voice recognition model according to an example embodiment of the present disclosure. In some embodiments, as shown in FIG. 3, recognizing the extracted keyword using the target voice recognition model includes the following processes.

At S10421, probability information of each standard keyword in the target voice recognition model relative to the extracted keyword is obtained.

The target voice recognition model includes one or more standard keywords. The probability information of the standard keyword relative to the extracted keyword indicates a degree of similarity between the extracted keyword and the standard keyword. Thus, the probability information of each standard keyword relative to the extracted keyword is determined based on the degree of similarity between each standard keyword and the extracted keyword.

For example, the target voice recognition model includes a first standard keyword, a second standard keyword, and a third standard keyword. The target voice recognition model is used to analyze the extracted keyword to determine that the degree of similarity between the first standard keyword and the extracted keyword is S1. The corresponding probability information P1 is obtained based on the degree of similarity 51. The degree of similarity between the second standard keyword and the extracted keyword is S2. The corresponding probability information P2 is obtained based on the degree of similarity S2. The degree of similarity between the third standard keyword and the extracted keyword is S3. The corresponding probability information P3 is obtained based on the degree of similarity S3. P1+P2+P3=1, and P1>P2>P3. Thus, the first standard keyword has the highest degree of similarity with the extracted keyword, and the third standard keyword has the lowest degree of similarity with the extracted keyword.

At S10422, the extracted keyword is recognized based on the probability information of each standard keyword relative to the extracted keyword.

In some embodiments, recognizing the extracted keyword based on the probability information of each standard keyword relative to the extracted keyword includes determining, from a plurality of standard keywords, a target keyword corresponding to the extracted keyword based on the probability information of each standard keyword relative to the extracted keyword.

Referring to the foregoing examples, the probability information of the first standard keyword relative to the extracted keyword is P1, the probability information of the second standard keyword relative to the extracted keyword is P2, the probability information of the third standard keyword relative to the extracted keyword is P3, and P1>P2>P3. Thus, a numerical relationship of the probability information can be used to determine the target keyword.

In some embodiments, determining a target keyword corresponding to the extracted keyword among multiple standard keywords based on the probability information of each standard keyword relative to the extracted keyword includes that when the probability information is greater than a preset probability threshold, the standard keyword corresponding to the probability information is determined to be the target keyword.

The probability threshold may be configured in advance. Those skilled in the art may configure the probability threshold based on specific design requirements. For example, the probability threshold may be 90%, 95%, or 98%. After the probability information of each standard keyword relative to the extracted keyword is obtained, the probability information is compared with the probability threshold. When the probability information of a certain standard keyword relative to the extracted keyword is greater than the preset probability threshold, it indicates that the standard keyword has a relatively high degree of similarity with the keyword extracted from the voice command. In this case, the standard keyword corresponding to the probability information is determined to be the target keyword.

Referring to the foregoing examples, the probability information of the first standard keyword in the target voice recognition model relative to the extracted keyword is 0.93, the probability information of the second standard keyword relative to the extracted keyword is 0.02, the probability information of the third standard keyword relative to the extracted keyword is 0.05. The three pieces of probability information are compared with the preset probability threshold (e.g., 0.90). The probability information 0.93 of the first standard keyword relative to the extracted keyword is greater than the preset probability threshold 0.9. It indicates that the first standard keyword has the relatively high degree of similarity with the keyword extracted from the voice command. Thus, the first standard keyword is determined to be the target keyword.

FIG. 4 is a flowchart of recognizing a keyword using probability information of each standard keyword relative to the extracted keyword according to an example embodiment of the present disclosure. In some embodiments, as shown in FIG. 4, recognizing the extracted keyword based on the probability information of each standard keyword relative the extracted keyword includes the following processes.

At S201, relative probability information between one standard keyword and another standard keyword is determined based on the probability information of each standard keyword relative to the extracted keyword.

The relative probability information is used to identify the degree of similarity of the probability information of different standard keywords relative to the same extracted keyword. Specifically, the relative probability information may be a ratio of a difference between two pieces of probability information of two standard keywords relative to the same extracted keyword over the probability information of one of the two standard keywords. That is, the relative probability information may be: (first probability information—second probability information)/first probability information or (first probability information—second probability information)/second probability information, and the relative probability information is greater than or equal to 0. The relative probability information described above is only one example. The relative probability information may be defined in different manners. For example, the relative probability information may be defined as a difference between two pieces of probability information or a ratio of two pieces of probability information.

Referring to the foregoing examples, the probability information of the first standard keyword relative to the extracted keyword is P1, the probability information of the second standard keyword relative to the extracted keyword is P2, the probability information of the third standard keyword relative to the extracted keyword is P3. The relative probability information between the first standard keyword and the second standard keyword may be (P1−P2)/P1, (P2−P1)/P1, (P1−P2)/P2, or (P2−P1)/P2. The relative probability information between the first standard keyword and the third standard keyword may be (P1−P3)/P1, (P3−P1)/P1, (P1−P3)/P3, or (P3−P1)/P3. The relative probability information between the second standard keyword and the third standard keyword may be (P2−P3)/P2, (P3−P2)/P2, (P2−P3)/P3, or (P3−P2)/P3.

At S202, the target keyword corresponding to the extracted keyword is determined among multiple standard keywords based on the probability information and the relative probability information.

After the probability information and the relative probability information are obtained, the probability information and the relative probability information are analyzed to determine the target keyword corresponding to the extracted keyword. In some embodiments, determining the target keyword corresponding to the extracted keyword based on the probability information and the relative probability information includes, when the probability information is greater than the preset probability threshold and the relative probability information is greater than or equal to a preset relative probability threshold, determining the standard keyword corresponding to the probability information and the relative probability information to be the target keyword.

The probability threshold and the relative probability threshold are preset. For example, the probability threshold may be 0.6, 0.55, or 0.5. Correspondingly, the relative probability threshold may be 0.1, 0.05, 0.01, or 0.15. After the probability information and the relative probability information are obtained, the probability information and the preset probability threshold are compared and analyzed, and at the same time, the relative probability information and the relative probability threshold are compared and analyzed. When the probability information of a certain standard keyword relative to the extracted keyword is greater than the preset probability threshold, and the relative probability information is greater than or equal to the relative probability threshold, it indicates that the certain standard keyword has substantially high degree of similarity with the keyword extracted from the voice command. The standard keyword corresponding to the probability information and the relative probability information is determined to be the target keyword.

FIG. 5 is a flowchart of determining a target keyword corresponding to the extracted keyword among multiple standard keywords based on the probability information and relative probability information according to an example embodiment of the present disclosure. Referring to FIG. 5, determining the target keyword corresponding to the extracted keyword among multiple standard keywords based on the probability information and relative probability information further includes the following processes.

At S2022, when the probability information is greater than the preset probability threshold and the relative probability information is smaller than the preset relative probability threshold, the first standard keyword and the second standard keyword corresponding to the relative probability information are obtained.

When the probability information of a certain standard keyword relative to the extracted keyword is greater than the preset probability threshold and the relative probability information is smaller than the preset relative probability threshold, it indicates that the two standard keywords have similar probability information. The two standard keywords may be the first standard keyword and the second standard keyword corresponding to the relative probability information.

For example, in the target voice recognition model, the probability information of the first standard keyword relative to the extracted keyword is 0.53, the probability information of the second standard keyword relative to the extracted keyword is 0.46, and the probability information of the third standard keyword relative to the extracted keyword is 0.01. Based on the probability information, the relative probability information between the first standard keyword and the second standard keyword is 0.132, the relative probability information between the first standard keyword and the third standard keyword is 0.981, and the relative probability information between the second standard keyword and the third standard keyword is 0.978. The probability information and the relative probability information are compared with the preset probability threshold 0.5 and the preset relative probability threshold 0.15. For the first standard keyword, the probability information 0.53 is greater than the preset probability threshold 0.5, and the relative probability information 0.132 is smaller than the preset relative probability threshold 0.15. It indicates that the probability information of the two standard keywords (i.e., the first standard keyword and the second standard keyword) corresponding to the relative probability information 0.132 are close. Thus, the first standard keyword and the second standard keyword are determined based on the relative probability information.

At S2023, the first standard keyword or the second standard keyword is determined to be the target keyword according to a preset priority processing strategy.

After the first standard keyword and the second standard keyword are obtained, the preset priority processing strategy is used to determine the target keyword. The priority processing strategy may be configured by the user. Specifically, the priority of the first standard keyword and the second standard keyword may be determined based on application scene requirements or usage requirements. Thus, the target keyword may be the first standard keyword or the second standard keyword.

Determining the target keyword in the foregoing manner effectively ensures the accuracy and the reliability of determining the target keyword, thereby improving the precision of using the method.

Further, after the target voice recognition model is used to recognize the voice command, the method consistent with the present disclosure can also include controlling the terminal device to perform a corresponding operation based on the target keyword.

After the target keyword is obtained, the terminal device is controlled to perform the operation corresponding to the target keyword. The terminal device may be controlled to perform the operation in the current operation state or after switching from the current operation state to another operation state. For example, the terminal device is the photographing device, and the current operation state is the camera operating state. Assuming that the target keyword is “burst-mode,” the photographing device is controlled to take multiple photos in a row based on the target keyword. Assuming that the target keyword is “photographing,” the photographing device is controlled to switch from the camera operating state to the photographing state based on the target keyword, and to perform the photographing operation in the photographing state.

Specifically, the target voice recognition model may include one or more state keywords related to state switching. Then, performing the corresponding operation by the terminal device based on the target keyword can include, when the target keyword is a state keyword in the target voice recognition model, controlling the terminal device to switch from the current operation state to the operation state corresponding to the state keyword based on the voice command.

For example, the terminal device is the photographing device, and the current operation state of the photographing device is the camera operating state. The state keyword in the target voice recognition model includes “photographing,” which corresponds to the photographing state of the photographing device. When the target keyword is “photographing,” the terminal device is controlled to switch from the current camera operating state to the photographing state based on the target keyword, and to perform the photographing operation.

In some embodiments, after the target keyword is determined, the terminal device is controlled to perform the corresponding operation based on the target keyword, which effectively improves the convenience for the user to control the terminal device and the adoption of the disclosed method.

FIG. 7 is a flowchart of a voice recognition method according to another example embodiment of the present disclosure. Referring to FIG. 7, the present disclosure provides a voice recognition method. For illustration purpose, the embodiments are described using the photographing device as the example of the terminal device. The photographing device may have different operation states and different operation states correspond to different voice recognition model. For example, when the photographing device is in a first operation state, voice commands that can be recognized by the voice recognition model include, for example, A1 (e.g., taking photos), B1 (e.g., video recording), and C1 (e.g., shut down). Correspondingly, the voice recognition model corresponding to the voice recognition function in the camera operating state is a first voice recognition model. When the photographing device is in a second operation state, voice commands that can be recognized by the voice recognition model include, for example, A2 (e.g., stop), and B2 (e.g., highlight). Correspondingly, the voice recognition model corresponding to the voice recognition function in the camera operating state is a second voice recognition model. By this analogy, in different operation states, the voice commands that need to be recognized are different, and different voice recognition models are needed.

Specifically, the voice recognition method includes the following processes.

A voice command inputted by a user is obtained.

The voice command is pre-processed by a preset pre-processor, such as smoothing, filtering, or noise canceling, to reduce interference and influence of external environmental factors on the voice command.

Feature extraction is performed on the pre-processed voice command to obtain an extracted keyword corresponding to the voice command.

An operation state of the photographing device is determined. The operation state is different from an operation mode of the photographing device. For example, the photographing device has different operation modes, such as a camera mode, a video mode, and a portrait mode. When no action is performed, an operation mode may be regarded as one operation state. That is, a state without continuous action. In this operation state, the photographing device may recognize voice commands such as “take photos,” video recording,” and “shut down.” When the photographing device is in the operation state of performing a continuous action, for example, when the photographing device is in a state of slow motion recording, burst-mode photographing, or 4KP60 recording, the photographing device may only recognize voice commands such as “stop” and “video frame label.” For example, when the photographing device is in the photographing state, the user speaks the voice command of “take photos.” In this scenario, the photographing device may refuse to recognize and perform the voice command.

A target voice recognition model corresponding to the operation state is determined. For example, when the photographing device is in operation state 1, the corresponding target voice recognition model is recognition model 1; when the photographing device is in operation state 2, the corresponding target voice recognition model is recognition model 2; and so on so forth. Different recognition models correspond to different standard keywords.

After the target voice recognition model is determined, the target voice recognition model is used to recognize the voice command to determine a candidate standard keyword. For example, the target voice recognition model is recognition model 1. Recognition model 1 is able to recognize four voice commands, such as “take photos,” video recording,” shut down,” and “burst-mode.” After the voice command is analyzed by recognition model 1, probability values corresponding to the standard keywords in recognition model 1 are obtained. For example, P(take photos)=0.8, P(video recording)=0.05, P(shut down)=0.03, P(burst-mode)=0.1, and P(refuse recognition)=0.02. Thus, the candidate standard keyword is determined.

The target keyword is determined based on the candidate standard keyword, and the photographing device is controlled to perform a corresponding operation based on the target keyword.

Specifically, the target keyword is the standard keyword corresponding to the maximum probability value P(take photos)=0.8. The standard keyword is considered as the recognized command. In some embodiments, the standard keyword having another probability value may be selected as the target keyword. For example, P(take photos)=0.5, P(video recording)=0.01, P(shut down)=0.02, P(burst-mode)=0.02, and P(refuse recognition)=0.45. Because P(take photos) and P(refuse recognition) are similar, the target keyword may be determined based on a preset priority processing strategy. For example, “refuse recognition” has a higher priority than “take photos.” Thus, the target keyword is determined to be “refuse recognition.”

When the photographing device is controlled to perform the corresponding operation based on the target keyword, the operation of the photographing device may be switched. For example, when the photographing device is in the camera operating state, and the user speaks “video recording” command, the photographing device is controlled to switch from the camera operating state to the photographing state, and to perform the video recording operation based on the “video recording” command.

In the voice recognition method provided by the embodiments of the present disclosure, different voice recognition models are used globally to improve a recognition rate of commands when the terminal device is in different operation states, and to focus on certain vocabulary in certain operation state. For example, the photographing device is in the photographing state, and only “stop” and “highlight” are valid commands, which are different from commands in other operation states, such as “video recording,” “shut down,” and “take photos.” When the photographing device is in the standby state, it is not needed to recognize the commands such as “stop.” In addition, from a logic point of view, the voice recognition method reduces the possibility of false recognition of unnecessary commands. The terminal device in certain operation state logically does not need to recognize certain commands, which can be removed directly to prevent false recognition of these unnecessary commands. Thus, the recognition efficiency and accuracy are improved, the complexity of the voice recognition model training is reduced, the practicality of the method is ensured, and market promotion and adoption are favorable.

FIG. 8 is a schematic structural diagram of a voice recognition device according to an example embodiment of the present disclosure. Referring to FIG. 8, the present disclosure provides a voice recognition device. The voice recognition device performs the disclosed voice recognition method. Specifically, the voice recognition device includes a memory 301 configured to store a computer program and a processor 302 configured to execute the computer program stored in the memory 301 to perform: obtaining a voice command inputted by a user for performing a voice control of a terminal device, determining an operation state of the terminal device, determining a target voice recognition model corresponding to the operation state, and recognizing the voice command using the target voice recognition model.

The terminal device may be a photographing device. The operation state of the photographing device includes at least one of a standby state, a camera operating state, or a photographing state.

In addition, the terminal device is provided with a state machine. When the processor 302 determines the operation state, the processor 302 is configured to obtain state data from the state machine, and determine the operation state of the terminal device based on the state data.

Further, when the processor 302 recognizes the voice command using the target voice recognition model, the processor 302 is configured to perform a feature extraction on the voice command to obtain an extracted keyword corresponding to the voice command, and recognize the extracted keyword using the target voice recognition model.

The target voice recognition model includes one or more standard keywords. When the processor 302 recognizes the extracted keyword using the target voice recognition model, the processor 302 is configured to obtain probability information of each standard keyword in the target voice recognition model relative to the extracted keyword, and recognize the extracted keyword based on the probability information of each standard keyword relative to the extracted keyword.

In some embodiments, when the processor 302 recognizes the extracted keyword based on the probability information of each standard keyword relative to the extracted keyword, the processor 302 is configured to determine a target keyword corresponding to the extracted keyword among multiple standard keywords based on the probability information of each standard keyword relative to the extracted keyword.

Specifically, when the processor 302 determines the target keyword corresponding to the extracted keyword among multiple standard keywords based on the probability information of each standard keyword relative to the extracted keyword, the processor 302 is configured to, when the probability information is greater than a preset probability threshold, determine the standard keyword corresponding to the probability information to be the target keyword.

In some embodiments, when the processor 302 recognizes the extracted keyword based on the probability information of each standard keyword relative to the extracted keyword, the processor 302 is configured to determine relative probability information between the standard keyword and another standard keyword based on the probability information of each standard keyword relative to the extracted keyword, and to determine the target keyword corresponding to the extracted keyword among multiple standard keywords based on the probability information and the relative probability information.

In some embodiments, when the processor 302 determines the target keyword corresponding to the extracted keyword among multiple standard keywords based on the probability information and the relative probability information, the processor 302 is configured to, when the probability information is greater than the preset probability threshold and the relative probability information is greater than or equal to a preset relative probability threshold, determine the standard keyword corresponding to the probability information and the relative probability information to be the target keyword.

In some embodiments, when the processor 302 determines the target keyword corresponding to the extracted keyword among multiple standard keywords based on the probability information and the relative probability information, the processor 302 is configured to, when the probability information is greater than the preset probability threshold and the relative probability information is smaller than the preset relative probability threshold, obtain a first standard keyword and a second standard keyword corresponding to the relative probability information, and to determine the first standard keyword or the second standard keyword to the target keyword according to a preset priority processing strategy.

Further, the processor 302 is configured to, after recognizing the voice command using the target voice recognition model, control the terminal device to perform a corresponding operation based on the target keyword.

The target voice recognition model includes one or more state keyword related to switching the operation state. When the processor 302 controls the terminal device to perform the corresponding operation based on the target keyword, the processor 302 is configured to, when the target keyword is a state keyword in the target voice recognition model, control the terminal device to switch from a current operation state to an operation state corresponding to the state keyword.

The voice recognition device provided by the embodiments of the present disclosure may be used to perform a method consistent with the disclosure, such as one of the example methods described above in connection with FIGS. 1-7. The execution details and beneficial effects are similar, and the description thereof is omitted.

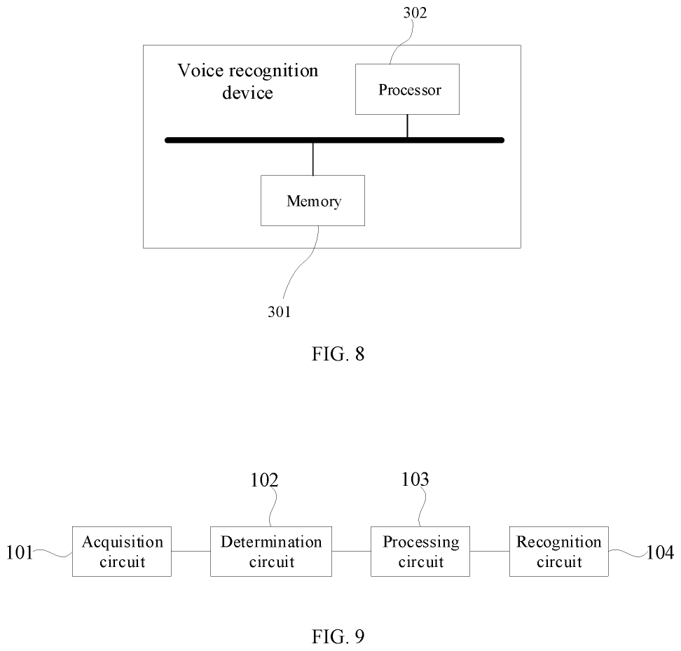

FIG. 9 is a schematic structural diagram of a voice recognition device according to another example embodiment of the present disclosure. Referring to FIG. 9, the present disclosure provides a voice recognition device. The voice recognition device performs the disclosed voice recognition method. Specifically, the voice recognition device includes an acquisition circuit 101 configured to obtain a voice command inputted by a user for performing a voice control of a terminal device, a determination circuit 102 configured to determine an operation state for the terminal device, a processing circuit 103 configured to determine a target voice recognition model corresponding to the operation state, and a recognition circuit 104 configured to recognize the voice command using the target voice recognition model.

The acquisition circuit 101, the determination circuit 102, the processing circuit 103, and the recognition circuit 104 provided by the embodiments of the present disclosure may be used to perform a method consistent with the disclosure, such as one of the example methods described above in connection with FIGS. 1-7. The execution details and beneficial effects are similar, and the description thereof is omitted.

The present disclosure also provides a photographing system. The photographing system includes a photographing device and a voice recognition device. The voice recognition device is communicatively connected to the photographing device. The voice recognition device includes a memory configured to store a computer program and a processor configured to execute the computer program stored in the memory to perform: obtaining a voice command inputted by a user for performing a voice control of a terminal device, determining an operation state of the terminal device, determining a target voice recognition model corresponding to the operation state, and recognizing the voice command using the target voice recognition model.

The voice recognition device in the photographing system provided by the embodiments of the present disclosure operates in the same way and provides the same beneficial effect as the voice recognition device shown in FIG. 8. The detailed description may be referred to the foregoing embodiments and will be omitted herein.

The present disclosure also provides a computer-readable storage medium. The computer-readable storage medium stores computer instructions. The computer instructions are used to implement the voice recognition method in the embodiments corresponding to FIGS. 1-7.

Under the circumstance of no conflict, the technical solutions and the technical features in the embodiments of the present disclosure may be individually operated or combined, as long as such combinations do not exceed the knowledges of those skilled in the art, and are within the scope of the present disclosure.

In the embodiments of the present disclosure, the disclosed terminal device and method may be implemented differently. For example, the terminal device described in the foregoing embodiments are intended to be illustrative. For example, division of circuits or modules are merely dividing logical functions. The actual implement may include different divisions. For example, multiple circuits or modules may be combined or integrated into another system. Certain features may be omitted or not executed. In addition, the shown or described mutual coupling or direct coupling or communicative connection may be implemented through a certain interface. The indirect coupling or communicative connection of the terminal device or circuits may be electrical, mechanical, or in another form.

The circuits described as separate parts may or may not be physically separated. The circuits shown as separate parts may or may not be physically separated, that is, may be located at one place, or may be distributed at multiple network elements. A part or all of the circuits may be selected to achieve the objective of the present disclosure based on the actual needs.

In addition, the functional units of various embodiments may be integrated into one processing unit or may be operated as physically separated units. Two or more functional units may be integrated into one functional unit. The unit integration may be implemented in hardware form or in software form.

When the integrated units are implemented as software functional modules and are sold and used as separate products, the software products may be stored in a computer-readable storage medium. Based on this understanding, the technical solutions of the present disclosure, the contribution in addition to the existing technology, or a part of all of the technical solutions may be implemented in software form. The computer software product stored in the storage medium may include computer instructions being executed by a computer processor 101 to implement a part or all of the processes in the method described in various embodiments. The storage medium includes various media for storing the computer instructions, such as a USB disk, a portable hard drive, a read-only memory (ROM), a random-access memory (RAM), a magnetic disk, or an optical disk.

The embodiments are merely examples of the present disclosure, which do not limit the scope of the present disclosure. Any equivalent structure or equivalent process transformation made by using the content of the description and drawings of the present disclosure, or directly or indirectly applied to other related technology fields, are included in the scope of the protection of the present disclosure.

In the specification, specific examples are used to explain the principles and implementations of the present disclosure. The description of the embodiments is intended to assist comprehension of the methods and ideas of the present disclosure. Those of ordinary skill in the art may change or modify the specific implementation and the scope of the application according to the embodiments of the present disclosure. Thus, the content of the specification should not be construed as limiting the present disclosure.

What is claimed is:

1. A voice recognition method comprising:
obtaining a voice command inputted by a user for performing a voice control of a terminal device;
determining an operation state of the terminal device;
determining a target voice recognition model corresponding to the operation state; and
recognizing the voice command using the target voice recognition model.

2. The method according to claim 1, wherein recognizing the voice command using the target voice recognition model includes:
performing a feature extraction on the voice command to obtain an extracted keyword corresponding to the voice command; and
recognizing the extracted keyword using the target voice recognition model.

3. The method according to claim 2, wherein:
the target voice recognition model includes one or more standard keywords; and
recognizing the extracted keyword using the target voice recognition model includes:
obtaining one or more probabilities of the one or more standard keywords relative to the extracted keyword; and
recognizing the extracted keyword based on the one or more probabilities.

4. The method according to claim 3, wherein recognizing the extracted keyword based on the one or more probabilities includes:
determining, from the one or more standard keywords, a target keyword corresponding to the extracted keyword based on the one or more probabilities.

5. The method according to claim 4, wherein determining, from the one or more standard keywords, the target keyword corresponding to the extracted keyword based on the one or more probabilities includes:
determining one of the one or more standard keywords that has a probability greater than a preset probability threshold to be the target keyword.

6. The method according to claim 3, wherein:
the one or more standard keywords include a plurality of standard keywords and the one or more probabilities include a plurality of probabilities each corresponding to one of the plurality of standard keywords; and
recognizing the extracted keyword based on the plurality of probabilities includes:
determining one or more relative probabilities each being between one of the plurality of standard keywords and another one of the plurality of standard keywords and being determined based on the probability of the one of the plurality of standard keywords and the another one of the plurality of standard keywords; and
determining, from the plurality of standard keywords, a target keyword corresponding to the extracted keyword based on the plurality of probabilities and the one or more relative probabilities.

7. The method according to claim 6, wherein determining, from the plurality of standard keywords, the target keyword corresponding to the extracted keyword based on the plurality of probabilities and the one or more relative probabilities includes:
determining one of the plurality of standard keywords that has a corresponding probability greater than a preset probability threshold and a corresponding relative probability greater than or equal to a preset relative probability threshold to be the target keyword.

8. The method according to claim 6, wherein determining, from the plurality of standard keywords, the target keyword corresponding to the extracted keyword based on the plurality of probabilities and the one or more relative probabilities includes:
determining, from the plurality of standard keywords, a first standard keyword and a second standard keyword with corresponding probabilities greater than a preset probability threshold and a corresponding relative probability smaller than a preset relative probability threshold; and
determining the first standard keyword or the second standard keyword to be the target keyword according to a preset priority processing strategy.

9. The method according to claim 1, further comprising, after recognizing the voice command using the target voice recognition model:
controlling the terminal device to perform a corresponding operation based on the target keyword.

10. The method according to claim 9, wherein:
the target voice recognition model includes one or more state keywords related to state switching; and
controlling the terminal device to perform the corresponding operation based on the target keyword includes:
in response to the target keyword being one of the one or more state keywords, controlling the terminal device to switch from a current operation state to an operation state corresponding to the one of the one or more state keywords based on the voice command.

11. The method according to claim 1, wherein:
the terminal device includes a state machine; and
determining the operation state of the terminal device includes:
obtaining state data stored in the state machine; and
determining the operation state based on the state data.

12. The method according to claim 1, wherein:
the terminal device includes a photographing device; and
the operation state of the photographing device includes at least one of a standby state, a camera operating state, or a photographing state.

13. A photographing system comprising:
a photographing device; and
a voice recognition device communicatively connected to the photographing device and including:
a memory storing a computer program; and
a processor configured to execute the computer program to:
obtain a voice command inputted by a user for performing a voice control of a terminal device;
determine an operation state of the terminal device;
determine a target voice recognition model corresponding to the operation state; and
recognize the voice command using the target voice recognition model.

14. The system according to claim 13, wherein the processor is further configured to execute the computer program to:
perform a feature extraction on the voice command to obtain an extracted keyword corresponding to the voice command; and
recognize the extracted keyword using the target voice recognition model.

15. The system according to claim 14, wherein:
the target voice recognition model includes one or more standard keywords; and
when recognizing the extracted keyword using the target voice recognition model, the processor is configured to:
obtain one or more probabilities of the one or more standard keywords relative to the extracted keyword; and
recognize the extracted keyword based on the one or more probabilities.

16. The system according to claim 15, wherein when recognizing the extracted keyword based on the one or more probabilities, the processor is configured to:
determine, from the one or more standard keywords, a target keyword corresponding to the extracted keyword based on the one or more probabilities.

17. The system according to claim 16, wherein when determining, from the one or more standard keywords, the target keyword corresponding to the extracted keyword based on the one or more probabilities, the processor is configured to:
determine one of the one or more standard keywords that has a probability greater than a preset probability threshold to be the target keyword.

18. The system according to claim 15, wherein:
the one or more standard keywords include a plurality of standard keywords and the one or more probabilities include a plurality of probabilities each corresponding to one of the plurality of standard keywords; and
when recognizing the extracted keyword based on the plurality of probabilities, the processor is configured to:
determine the one or more relative probabilities, each being between one of the plurality of standard keywords and another one of the plurality of standard keywords and being determined based on the probability of one of the plurality of standard keywords and the another one of the plurality of standard keywords; and
determine, from the plurality of standard keywords, a target keyword corresponding to the extracted keyword based on the plurality of probabilities and the one or more relative probabilities.

19. The system according to claim 18, wherein when determining, from the plurality of standard keywords, the target keyword corresponding to the extracted keyword based on the plurality of probabilities and the one or more relative probabilities, the processor is configured to:
determine one of the plurality of standard keywords that has a corresponding probability greater than a preset probability threshold and a corresponding relative probability greater than or equal to a preset relative probability threshold to be the target keyword.

20. The system according to claim 18, wherein when determining, from the plurality of standard keywords, the target keyword corresponding to the extracted keyword based on the plurality of probabilities and the one or more relative probabilities, the processor is configured to:
determine, from the plurality of standard keywords, a first standard keyword and a second standard keyword with corresponding probabilities greater than a preset probability threshold and a corresponding relative probability smaller than a preset relative probability threshold; and
determine the first standard keyword or the second standard keyword to be the target keyword according to a preset priority processing strategy.
